(19) United States
(12) Patent Application Publication
(10) Pub. No.: US 2024/0207959 A1
(43) Pub. Date: Jun. 27, 2024

(54) METHOD OF ELECTROCHEMICALLY MACHINING AND ELECTRODE

(71) Applicant: Cummins Ltd., London (GB)

(72) Inventors: Robert L. Holroyd, Huddersfield (GB); Thomas Roberts, Huddersfield (GB); Laura Sullivan, Huddersfield (GB)

(21) Appl. No.: 18/288,441

(22) PCT Filed: Apr. 27, 2022
(86) PCT No.: PCT/GB2022/051069

§ 371 Date: Oct. 26, 2023

(30) Foreign Application Priority Data
Apr. 27, 2021 (GB) 2106007.4

(51) Int. Cl. B23H 3/04; B23H 7/26; C25F 7/00; C25F 3/20; C25F 3/24

(52) U.S. Cl. CPC B23H 3/04; B23H 7/26; C25F 7/00; C25F 3/20; C25F 3/24

(57) ABSTRACT

There is disclosed a method of electro-chemically machining a cavity of a component using a flexible electrode. The flexible electrode comprises: a flexible core; a conductive body electrically coupled to the core; and a non-conductive body. The method comprises: inserting the flexible electrode through an opening and along the cavity, the non-conductive body engaging an internal wall of the cavity; and applying a negative charge to the flexible electrode, and providing a flow of electrolyte through the cavity to remove material from the internal wall.

### CROSS-REFERENCE TO RELATED APPLICATIONS

The present application claims the benefit of priority to International Patent Application No. PCT/GB2022/051069, filed Apr. 27, 2022, which claims the benefit of priority to GB Patent Application No. 2106007.4, filed Apr. 27, 2021, the contents of which are incorporated herein by reference in their entirety.

### FIELD

The present invention relates to a method of electrochemically machining a cavity of a component; a flexible electrode; and a component.

### BACKGROUND

Electrochemical machining is a known process that is used to remove welded joints and to polish internal passages of tubes. In the process, a positively charged workpiece forms an anode. The workpiece, or at least an exposed surface thereof, is spaced apart (to define a gap) from a negatively charged electrode, which forms a cathode. An electrolyte is pumped through the gap provided between the workpiece and the electrode. The electrolyte effectively completes the electrical circuit between the electrode and workpiece (cathode and anode respectively). Atoms are removed from the exposed surface of the workpiece as electrons cross the gap, resulting in an improved surface finish of the workpiece.

Existing electrochemical machining processes, and associated apparatuses, limit the use of the process to only some workpieces.

There exists a need to overcome one or more disadvantages associated with existing arrangements, whether mentioned in this document or otherwise.

### SUMMARY

According to a first aspect of the disclosure there is provided a method of electrochemically machining a cavity of a component using a flexible electrode, the flexible electrode comprising:
a) a flexible core;
b) a conductive body electrically coupled to the core; and
c) a non-conductive body; the method comprising:
d) inserting the flexible electrode through an opening and along the cavity, at least part of an outer profile of the non-conductive body engaging an internal wall of the cavity; and
e) applying a negative charge to the flexible electrode, and providing a flow of electrolyte through the cavity to remove material from the internal wall.

Advantageously, electrochemical machining can achieve a surface finish which is similar to a polished standard. Furthermore, the surface finish obtained using electrochemical machining can be achieved in only a few minutes, which is considerably faster than is the case for traditional polishing. Advantageously, electrochemical machining can be used to provide an improved surface finish for a number of different materials including, but not limited to, aluminium, cast-iron and stainless steel. Furthermore, electrochemical machining can occur without there being any contact between the conductive body and the internal wall. Wear of the conductive body is therefore reduced as a result.

Advantageously, the flexible electrode can be used to electrochemically machine a variety of different cavity geometries. For example, the cavity may be a volute (i.e. a generally spiralling geometry of a turbomachine housing). The flexible electrode can be used to readily electrochemically machine nonlinear cavities (i.e. cavities incorporating at least one bend, such that a rigid electrode could not extend past the bend).

Electrochemical machining is intended to mean a process in which an electrolyte is passed through a gap between a negatively charged tool (cathode) and a positively charged workpiece (anode) to remove material from the workpiece. The electrolyte completes an electrical circuit (interrupted by the gap between the anode and cathode) to remove material, and transport it away, from the workpiece. In this instance it will be appreciated that the component is an example of a workpiece. The flexible electrode is an example of a tool. The component (to be machined) is preferably made of an electrically conductive material.

The cavity may have any one of a variety of different shapes. For example, the cavity may be generally cylindrical (e.g. having a generally circular cross-section). Alternatively, the cavity may be generally cuboidal (e.g. having a generally square, or rectangular, cross-section). The cavity may have a nonlinear geometry (i.e. it may incorporate one or more bends along its extent, or length). The cavity may be a volute. Specifically, the cavity may be a volute formed in a housing of a turbomachine housing (e.g. a turbine housing or compressor housing). The cavity may be defined by the opening. The cavity may have a discharge aperture. The electrolyte may flow through the opening of the cavity, along the internal wall of the cavity, and exit via the discharge outlet. Providing the flow of electrolyte may comprise pumping the electrolyte. Pumping the electrolyte may provide a stream of electrolyte. Providing the flow of electrolyte may comprise driving (e.g. pumping) electrolyte through the cavity. Electrolyte may be driven, or urged, through the cavity continuously during the machining process. The electrolyte may be described as actively flowing through the cavity during machining. The electrolyte may enter the cavity through a first opening (of the cavity) and be discharged from the cavity via a second opening (of the cavity). The electrolyte flow advantageously provides a flushing functionality (in which machined material is removed from the cavity) and a cooling functionality (in which at least the electrode is cooled by at least convection).

The electrolyte may be saltwater or any other fluid which provides a flow of ions. A mild acid solution is another example of a suitable electrolyte. The electrolyte may include Sodium Nitrate and/or Sodium Chloride. The concentration may range from around 15% to around 30% by volume. Where a combination of Sodium Nitrate and Sodium Chloride is included, the ratio of Sodium Nitrate to Sodium Chloride may be, for example, around 80:20, around 70:30 or around 60:40 by volume. The electrolyte may consist of 100% Sodium Nitrate at a concentration, by volume, of between around 15% and around 30%.

The component may be any one of a range of different components. Examples include a manifold, turbomachine housing (e.g. a turbine housing or a compressor housing, or another variety of pump housing) or an EGR valve. The component may be a turbine housing, or compressor housing, for a turbocharger. Where the component is a compressor housing, the compressor housing may be for an eCompressor (i.e. a compressor driven by an electric motor, or generator). The eCompressor may form part of an eTurbocharger. The component may an engine component.

For the purposes of this document, the electrochemical machining of the cavity is intended to refer to the effective polishing of a preformed cavity. That is to say, the cavity is not created, in a solid surface for example, by the electrochemical machining process. Rather, the surface finish of an existing cavity is improved, by reducing its surface roughness, using electrochemical machining. This is owing to the fact that the electrode is inserted into a cavity, in order for the process to be carried out.

The flexible electrode refers to an electrode which is able to bend by at least 45° along its length. That is to say, the flexible electrode can be inserted through a cavity which incorporates a 45° bend, and the flexible electrode can flex to conform to the bend (or accommodate it). The flexible core may be a wire. The flexible core may be a braided wire. The flexible core is conductive. The flexible core may run along an entire extent of the flexible electrode. That is to say, the length of the flexible core may define a length of the electrode. Alternatively, the flexible core may only run along a proportion of the entire extent, or length, of the electrode. The flexible core may be an electrical cord. The flexible core may be a central electrical cord.

The conductive body refers to a body that is electrically conductive. That is to say, the conductive body readily permits a flow of electrons thereacross. The conductive body forms part of an electrical circuit. The conductive body may consist of a single part or piece. Alternatively, the conductive body may comprise a plurality of constituent parts or pieces. The conductive body may comprise a plurality of conductive plates. The conductive body may comprise a plurality of conductive body elements. The conductive body may be integrally formed with the flexible core. Alternatively, the conductive body may be attached to the flexible core in a manufacturing step. For example, the conductive body may be crimped to the flexible core. The conductive body may be crimped using a nut and olive crimp. Alternatively, the conductive body may be attached to the flexible core using one or more fasteners. The conductive body being electrically coupled to the core is intended to mean that the conductive body and flexible core are in electrical communication with one another. That is to say, the conductive body is electrically connected to the flexible core. The conductive body may be secured to the flexible core at a given position and remain attached to the flexible core for the duration of the lifetime of the flexible electrode. Examples of materials that the conductive body may be manufactured from include metals. Whilst most hard-wearing metals are suitable, stainless steels, such as 300 and 400 series stainless steels, are particularly desirable owing to their corrosion resistance. 300 and 316 series stainless steels have been found to be particularly effective.

A non-conductive body generally refers to a body which is an insulator. That is to say, the non-conductive body does not readily permit a flow of electrons thereacross. Examples of materials that the non-conductive body can be made from include plastics and ceramics. The non-conductive body may be attached to the flexible core. Alternatively, the non-conductive body may be attached to the conductive body. The non-conductive body may consist of a single part or piece. Alternatively, the non-conductive body may comprise a plurality of constituent parts or pieces. The non-conductive body may comprise a plurality of non-conductive plates. The non-conductive body may comprise a plurality of rollers. The non-conductive body may be said to be for engaging the internal wall of the cavity. The non-conductive body may be said to be for engaging an interior of the cavity. The non-conductive body may space the conductive body apart from the internal wall. That is to say, the conductive body may be effectively suspended by the non-conductive body in the cavity. The non-conductive body may be said to define a gap between an outer profile of the conductive body and the internal wall.

Inserting the flexible electrode through the opening refers to inserting the flexible electrode through an opening of the cavity. That is to say, the flexible electrode may be said to be inserted into the cavity. The flexible electrode may be said to penetrate the cavity. Inserting the flexible electrode along the cavity is intended to mean that the flexible electrode passes at least partway through an extent, or length, of the cavity. The flexible electrode may be passed through an entirety of the cavity i.e. a distal end of the flexible electrode may abut an end wall, end point, or tip of the cavity. Alternatively, the flexible electrode may extend only partway through the cavity. That is to say, there may still be an extent of the cavity which is not occupied by the flexible electrode.

The non-conductive body engaging an internal wall of the cavity is intended to mean that at least part of the non-conductive body contacts, or abuts, the internal wall of the cavity. Alternatively, a majority, or an entirety, of the non-conductive body may engage the internal wall of the cavity. An entirety of the outer profile of the non-conductive body may engage the internal wall. The outer profile of the non-conductive body may conform to the profile of the internal wall of the cavity. That is to say, a cross-section geometry of the non-conductive body may be generally the same as a cross-section geometry of the internal wall. Similarly, a profile of the conductive body may conform to an internal wall of the cavity.

Advantageously, when at least part of the outer profile of the non-conductive body engages the internal wall of the cavity, the electrode can be more readily inserted, and guided along, the cavity. That is to say, the non-conductive body may form a guide which assists with the insertion of the electrode through the cavity. Specifically, the non-conductive body may assist with the alignment of the core, and the conductive body, within the cavity. This is advantageous in more effectively aligning the conductive body with the internal wall which is to be machined.

The aforementioned engagement is also advantageous in conforming the flexible electrode to the cavity. For example, where the cavity is a volute having a generally spiral geometry, the outer profile of the conductive body engaging the internal wall means that the flexible core flexes to match the generally spiral geometry of the cavity. This ensures the electrode conforms to the cavity along the length of the electrode. In turn, the conductive body is aligned with the internal wall along the length of the electrode.

The at least part of an outer profile of the non-conductive body may comprise an entire outer profile of the non-conductive body. Where the non-conductive body is a plate, for example, the conductive body may have a circular cross-section. The non-conductive body may therefore be referred to as a disc. An entire or, substantially entire, outer annular profile of the disc may engage the internal wall of the cavity. It will be appreciated that, in order to be facilitate the insertion of the electrode into the cavity; there may be at least some degree of clearance between the outer profile of the non-conductive body and the internal cavity. However, the aforementioned engagement refers to there being contact with at least some points around the outer profile.

In other arrangements, the non-conductive body may comprise a plurality of non-conductive rollers, which are rotatably coupled to the conductive body (optionally an exterior thereof). In such instance, rotation of the rollers may facilitate the insertion of the electrode into the cavity. It will therefore be appreciated that, where rollers are used, only a portion of the outer profile of the roller may engage the internal wall of the cavity at any one time (depending upon the part of the roller which is in contact with the internal wall).

In preferred arrangements, there are at least three points of contact between the outer profile of the non-conductive body and the internal wall of the cavity. This has been found to provide sufficient positional guidance whilst still facilitating the flow of electrolyte past the non-conductive body (and along the cavity).

Applying a negative charge to the flexible electrode is intended to mean that the electrode is negatively charged. In other words, the flexible electrode is the cathode in the electrochemical machining process summarised above. The negative charge may be applied to the conductive body directly. Alternatively, the negative charge may be applied to the conductive body indirectly, via the flexible core (to which the conductive body is electrically coupled). A negative charge may be applied by connecting the flexible electrode to a power supply. The power supply may a DC (direct current) power supply. The component may be connected to a positive terminal of a power supply (to define a cathode). The electrode may be connected to a negative terminal of a power supply (to form an anode).

Pumping a flow of electrolyte through the cavity may be described as urging an electrolyte flow through the opening, along the cavity, and out of the cavity via a discharge outlet. The flow of electrolyte may suspend material removed from the internal wall, through the cavity, and out of the cavity via the discharge outlet.

Removing material from the internal wall may be referred to as polishing the internal wall. Removing material from the internal wall may otherwise be referred as reducing a surface roughness of the internal wall. Removing material from the internal wall may be referred to as improving a surface finish of the internal wall.

The method is not limited to carrying out the steps in the order set out in the claim. For example, the negative charge may be applied to the electrode before the electrode is inserted through the opening and along the cavity (although, in practice, it is anticipated that the electrode will be fully inserted into the cavity before power is switched on and the charge is applied). Similarly, electrolyte may be pumped through the cavity before the electrode is inserted. With that said, the electrode may be inserted before the negative charge is applied to the electrode. Similarly, the electrolyte may be pumped through the cavity after the electrode has been inserted, and optionally after the negative charge is applied to the electrode.

The non-conductive body and/or conductive body may have cross section dimensions of between around 15 mm and 80 mm in width (e.g. a major dimension, in an axial direction), and between around 40 mm and around 100 mm in height (e.g. a minor dimension, in a radial direction). The non-conductive body and/or conductive body may have an aspect ratio of between around 1 and around 3 when viewed in cross section.

At an end of the electrode which is proximate the opening, at least part of the non-conductive body may project outwardly beyond the opening. Said at least part of the non-conductive body may engage an outer face of a flange in which the opening is formed. An adjacent part of the conductive body may project outwardly beyond the opening and the non-conductive body. As such, at least part of the conductive body may be in facing relations with the outer face of the flange, separated by a gap which is provided by the non-conductive body. Said at least a part of the conductive body may be described as an exposed part of the conductive body.

The exposed part of the conductive body may be used to machine a feature into the end face of the flange. This can provide a visual indicator (e.g. a poka-yoke) that the cavity has been polished, and polished to its full depth. The feature can also be used as a non-functional counterfeit detection feature.

The arrangement of part of the conductive and non-conductive bodies extending outwardly beyond the opening may be described as an arm. The arm may be said to extend generally radially. A machining feature may be provided at an end of the arm. An example of the machining feature is a hemisphere having, for example, a 5 mm diameter, although it will be appreciated that a wide range of other geometries, and features, could otherwise be machined into the outer face. The feature may be applied to an exterior of the component (e.g. an outer face of a flange) or an interior of the component (e.g. to the internal wall).

Where the electrode comprises a plurality of conductive bodies and/or a plurality of non-conductive bodies, the bodies may be manufactured using a laser cutting process, waterjet cutting process, or an additive manufacture process.

The electrode may be manufactured using an additive manufacture process. Manufacturing the electrode using an additive manufacture process, such as a 3D printing process, may be particularly advantageous for incorporating features such as slots and apertures (for receipt of roller axles) in the conductive body.

The method may further comprise reciprocating the electrode within the cavity.

Advantageously, reciprocating the electrode within the cavity ensures that a greater proportion of the internal wall is machined by the electrochemical machining process. That is to say, by reciprocating the electrode, the conductive body is exposed to a greater extent of the internal wall than if the electrode was stationary.

Reciprocating the electrode is intended to mean that the electrode is urged in alternating directions within the cavity. For example, in a first step the electrode may be inserted further into the cavity by urging the electrode in a direction along the extent of the cavity. In a subsequent step, the electrode may be urged in the opposite direction, but still along an extent of the cavity. Put another way, in the first step a point on the electrode may be urged in a direction moving from the opening towards a discharge outlet of the cavity, along an extent of the cavity. In a subsequent step, the electrode may be urged in the opposite direction back towards the starting position of the previous step.

Reciprocating the electrode in the cavity is particularly beneficial when the conductive body comprises a plurality of conductive plates or elements. Reciprocation means that more than one of the plurality of conductive plates, or body elements, is exposed to a particular portion of the internal wall.

The electrode may be reciprocated by between around 5 mm and around 10 mm.

Reciprocating the electrode by between around 5 mm and around 10 mm has been found to be particularly effective when the cavity is a volute.

Another way of defining the extent to which the electrode reciprocates is in relation to a distance between the plurality of conductive plates or elements when the conductive body comprises said plurality of conductive plates or elements. It is preferable that the electrode reciprocates by at least the distance between adjacent conductive plates or elements. Doing so ensures that all of the internal cavity, along the extent of the electrode, is exposed to a conductive plate, conductive element or other conductive body part constituting the conductive body. Put another way, the electrode is preferably reciprocated by a magnitude (or extent) sufficient to expose all of the internal wall, which is to be electrochemically machined, to the conductive body.

Reciprocating the electrode within the cavity may facilitate driving electrolyte through the cavity. For example, incorporating of a one-way valve, or similar feature (e.g. a membrane), as part of the electrode, may mean that electrolyte is substantially prevented from flowing against a stroke of the electrode in a first direction. Movement of the electrode in the first direction may thus drive, or force, electrolyte in the first direction also. This may be described as a passive driving of electrolyte, which may mean a pump can be omitted. This may be particularly advantageous where the non-conductive body comprises one or more cavities (through which electrolyte can flow).

A low power test may be conducted before an operational power is supplied to the electrode.

Low power test refers to an initial check of the system, after the electrode has been inserted. The low power test can be run to check for any short circuit, which may indicate (undesirable) contact between the electrode and the component. Put another way, a failed low power test may be indicative of a misalignment of the electrode within the cavity.

A successful low power test provides the operator with an indication that the electrode is correctly aligned within the cavity. The operator can then provide an operational power to the electrode, to begin the electrochemical machining process. The operational power may be described as a full electrochemical process power.

Advantageously, the low power test reduces the risk that the electrode becomes welded to the internal wall of the cavity due to a misalignment of the electrode within the cavity.

The component may be grounded to earth.

Grounding the component to earth means that substantially any static is discharged from the component. Advantageously, this means that when the flexible electrode is negatively charged, and therefore forms a cathode, the workpiece effectively forms the anode by virtue of having a greater positive charge. Grounding the component to earth, in combination with providing the electrolyte, therefore completes the circuit to facilitate the electrochemical machining of the component.

The core may be electrically connected to a DC power supply.

Advantageously, electrically connecting the core to a DC power supply provides a convenient means of applying the negative charge to the flexible electrode. The DC power supply is also readily adjustable if needed. Further advantageously, by electrically connecting the core to the DC power supply, the conductive body, which is electrically coupled to the core, is also effectively negatively charged. Where the conductive body comprises a plurality of conductive plates, or a plurality of conductive elements, each of said constituent parts of the conductive body is also negatively charged and will therefore provide an electromechanical machining effect upon the cavity.

The DC power supply may have an output amperage of at least around 100 A.

The DC power supply having an output amperage of at least 100 A has been found to be effective for use with an electrochemical machining process.

The output amperage may be around 140 A, around 1 kA, around 1.5 kA or around 2.5 kA. The output amperage may be up to around 5 kA.

The DC power supply may have an output voltage of at least around 10 V.

It will be appreciated that the output voltage may be −10 V, depending upon which terminal of the power supply the output is taken from.

The output voltage may be around 20 V, or around 40 V. For health and safety reasons, it is desirable that the output voltage does not exceed around 50 V.

At least a part of the outer profile of the non-conductive body may projects beyond an outer profile of the conductive body.

Advantageously, at least part of the outer profile of the non-conductive body projecting beyond an outer profile of the conductive body effectively means that the outer profile of the conductive body can be spaced apart, or separated, from the internal wall. That is to say, a clearance, or gap, may exist between the internal wall (which is to be machined) and the outer profile of the conductive body. Spacing the conductive body apart from the internal wall in this manner is useful in reducing the risk of a short circuit occurring. Furthermore, by providing a separation between the internal wall and outer profile of the conductive body, arcing can be reduced or alleviated altogether. The separation, or gap, facilitates the electrochemical machining process.

The at least a part of the outer profile of the non-conductive body may project beyond the outer profile of the conductive body by between around 0.2 mm and around 3 mm, and preferably between around 0.5 mm and around 1 mm, radially. The extent to which the outer profile of the non-conductive body projects beyond the outer profile of the conductive body may be greater than the aforementioned values if compensated for by supplying the electrode with more power, during the process.

The outer profile of the conductive body may be spaced apart from the internal wall of the cavity by between around 0.3 mm and around 2.5 mm radially.

The outer profile of the conductive body may be spaced apart from the internal wall by an amount which is greater than the aforementioned values, if compensated for by supplying the electrode with more power,

Spacing the outer profile of the conductive body from the internal wall by the aforementioned range is advantageous in reducing the risk of arcing occurring between the conductive body and the internal wall. Arcing is undesirable because it can result in a significant amount of power passing through a small contact area, which can create a spark and/or weld the two parts together at the contact location.

The non-conductive body may comprise a plurality of non-conductive plates.

Advantageously, the plurality of non-conductive plates provides a convenient means of locating the electrode within the cavity. This is particularly effective when the cavity is generally tubular i.e. has a generally circular cross-section which extends along an extent, or length, of the cavity.

Plates refers to a part having a cross-section and an associated thickness, where the thickness is a minor dimension. That is to say, it refers to a part which has a smaller thickness than it does an x-y dimension (normal to the cross-section). The plates are manufactured from a plastic or ceramic material, to name two examples. One specific example of a suitable material is nylon.

Where the non-conductive body comprises a plurality of non-conductive plates, the plates may be referred to as spacers. This may be owing to the fact that the plates are provided between conductive plates along the length of the electrode.

The non-conductive plates are an example of a non-conductive body. That is to say, the non-conductive body may comprise a plurality of non-conductive bodies. A further example of a non-conductive body is a non-conductive roller. The non-conductive body may be said to comprise an array of non-conductive body, which may be an array, or series, of non-conductive plates. The array, or series, may be a linear array or series.

The non-conductive body may comprise at least 10 non-conductive plates, at least 20 non-conductive plates or, in some instances, at least 30 non-conductive plates. The non-conductive body may comprise upwards of 50 non-conductive plates.

The plurality of non-conductive plates may each be attached to the core individually. That is to say, each plate may be separately, and individually, attached to the core. Alternatively, the non-conductive plates may be integrally formed with the flexible core.

Adjacent plates may be separated, or offset, from one another by at least around 1 mm, or at least around 2 mm. Such clearance facilitates the flexing of the electrode by reducing the risk of adjacent plates fouling on one another as the electrode flexes. The aforementioned separation values are desirable for plates having a thickness of around 5 mm.

The non-conductive plates may be solid. Alternatively, the non-conductive plates may comprise one or more cavities. Such non-conductive plates may be described as non-solid, skeletal, hollow or having a honeycomb structure. The cavities are advantageous in providing apertures through which electrolyte can flow in use, which facilitates the electrochemical machining process. That is to say, electrolyte may be able to flow across, or through, the non-conductive plate, through the cavities. Hollowing out the non-conductive body is also advantageous in saving material and reducing the weight of the electrode.

The non-conductive plates may have any one of a number of different shapes e.g. triangular, circular, square, rectangular, pentagonal, star-shaped. The shape of the non-conductive plate may differ from the shape of a conductive plate.

The conductive body may comprise a plurality of conductive plates.

Advantageously incorporating a plurality of conductive plates means that the electrode can extend through a nonlinear cavity whilst the non-conductive body still engages the internal wall thereof. The plurality of non-conductive plates is also advantageous in allowing the electrode to be inserted within a range of different cavity geometries. For example, the cavity may generally taper from a larger opening cross-sectional area to a smaller cross-sectional area at a distal end of the cavity. Sizing the plurality of conductive plates appropriately means that the conductive body can still engage the internal wall despite this variance in geometry.

Advantageously, the plurality of non-conductive plates may offer a desirable balance of surface area (which is exposed to the internal wall), providing a good coverage of electrochemical machining; and flexibility of the electrode to be received in cavities of varying geometries.

The plurality of conductive plates may be integrally formed with the flexible core. Alternatively, the plurality of conductive plates may be separate to the flexible core initially, and may be subsequently attached to the flexible core. The plurality of conductive plates may be manufactured from the same material as the flexible core. Alternatively, the plurality of conductive plates may be manufactured from the material which is different to the flexible core.

The plurality of conductive plates may each have a common thickness. That is to say, the plurality of conductive plates may each extend by the same extent along a length of the electrode. Alternatively, the plurality of conductive plates may have different thicknesses. The plurality of conductive plates may have the same thickness as each of the non-conductive plates. The conductive plates each have a thickness of between around 5 mm and around 20 mm.

The conductive plates are an example of a conductive body. That is to say, the conductive body may comprise a plurality of conductive bodies. A further example of a conductive body is a conductive body element. The conductive body may be said to comprise an array of conductive bodies, which may be an array, or series, of conductive plates. The array, or series, may be a linear array or series.

The conductive body may comprise at least 10 conductive plates, at least 20 conductive plates or, in some instances, at least 30 conductive plates. The conductive body may comprise upwards of 50 conductive plates.

The plurality of conductive plates may interpose the plurality of non-conductive plates.

Advantageously, this arrangement means that the non-conductive plates can effectively space the conductive plates from the internal wall in a relatively uniform manner. It facilitates insertion of the electrode within a nonlinear cavity (e.g. a cavity incorporating a bend, such as a 90° bend) whilst still ensuring the internal wall is electrochemically machined to a desirable level.

The plurality of conductive plates interposing the plurality of non-conductive plates is intended to mean that the electrode comprises an arrangement of plates which is conductive, non-conductive, conductive, non-conductive etc. Put another way, a conductive plate is adjacent a non-conductive plate which, in turn, is adjacent a further conductive plate. The arrangement can otherwise be described as an alternating array of plates (specifically conductive and non-conductive). Put another way, the non-conductive plates may be in facing relations with a further two non-conductive plates (other than at outer ends of the electrode). A non-conductive, or conductive, plate may be said to be sandwiched between conductive, or non-conductive, plates.

An outer profile of the plurality of conductive plates and the plurality of non-conductive plates may generally taper from a first end of the electrode to a second end of the electrode. That is to say, a cross-sectional area of the outer profile of the first end of the electrode may be larger than a cross-sectional area of the outer profile of the second end of the electrode. Advantageously, this means the electrode, specifically the conductive plates, can conform to the internal wall of a comparatively tapering cavity, such as a turbomachine housing volute, for example. The tapering may be linear, or nonlinear (i.e. may follow an arcuate profile). The tapering is intended to refer to the outer profile of the conductive body, and non-conductive body, and may exclude the outer profile of the flexible core (which may project beyond the second end of the electrode, and have a comparatively small cross-section). An extent, or length, of the electrode comprising the conductive body and non-conductive body may be referred to as a body portion of the electrode. It may be the outer profile of the body portion which tapers from the first end to the second end of the electrode.

The method may further comprise providing the conductive body with a plurality of conductive body elements.

Put another way, the conductive body may comprise a plurality of conductive body elements. Conductive body elements may refer to bodies which are conductive and which have a dimension along a length of the electrode which is greater than an extent of their cross-sectional area. That is to say, the elements may be thicker than they are wide. Put another way, the elements may be elongate.

Advantageously, the plurality of conductive body elements reduce the number of conductive components required to facilitate the electrochemical machining along a length of the internal wall. This is primarily due to the geometry of the elements, the elements occupying a larger proportion of the extent of the cavity. Providing fewer components is desirable for a reduced component count and reduced maintenance requirement. Furthermore, troubleshooting, if there any issues during the process, is made simpler by virtue of the fact that there are fewer conductive body elements.

The elements may be generally tubular. That is to say, the elements may be circular in cross-section and may extend along a length of the electrode. The conductive body elements may be said to be generally frustoconical i.e. having the geometry of a cone with its tip cut off. That is to say, an exterior of the elements may taper along a length of the elements. The elements may be described as tapering tubes, or tapering cylinders. It will be appreciated that the elements may be adapted to conform to a range of different cavities, and so associated internal walls.

The conductive body may consist of up to 4, up to 8, or up to 12 elements. The conductive body may comprise at least 4 or at least 8 elements.

The elements may be arranged in an end to end manner along a length of the electrode. That is to say, an end face of one element may be in facing relations with an adjacent end face of an adjacent element. A clearance may be provided between adjacent conductive body element to allow the conductive body element to conform to the internal wall of the cavity. For example, where the cavity is a volute of a turbomachine housing, a clearance between adjacent conductive body elements may allow the flexible core to deform to the generally spiral geometry of the volute. This may be facilitated by a clearance between the conductive body elements, which allows a degree of movement between the body elements so that they can conform to the internal wall without fouling on one another. It will be appreciated that the clearance may only be designed (e.g. by incorporation of a recess, or by selecting a separation between adjacent body elements) on a radially inner side of the elements, as it is this side of the elements which are proximate one another when the electrode flexes (and so which would otherwise foul on one another). In contrast, the elements separate from one another at a radially outer side of the elements when the electrode flexes (and so there is a gap, or clearance, present by virtue of the flexing of the electrode). This also applies to an embodiment incorporating conductive, and non-conductive, plates. The clearance between adjacent body elements may be determined, at least in part, by the number and length of the body elements. A larger clearance may be incorporated for a comparatively longer body element (to allow the adjacent body elements to conform to the cavity).

The conductive body elements may attach to the flexible core. The conductive body elements may attach to the flexible core by passing through an aperture provided in the conductive body element. The aperture may form part of a channel which is configured to receive the flexible core. Fasteners, such as a bolt or screw, may be used to secure the conductive elements to the flexible core. The conductive body elements may therefore be fixedly attached to the flexible core.

The non-conductive body may comprise a plurality of non-conductive rollers.

Advantageously, the non-conductive rollers provide a convenient means of guiding the electrode, and so conductive body, through the cavity. The non-conductive rollers may engage the internal wall and thereby separate, or offset, an outer profile of the conductive body from the internal wall. This facilitates the electrochemical machining process.

Advantageously, the non-conductive body comprising a plurality of non-conductive rollers provides a convenient, and low wearing, means of engaging the internal wall. Using non-conductive rollers may also mean the electrode can be inserted more easily, and with a lower insertion force, than alternative frictional engagements (i.e. a sliding engagement). This may reduce the risk of damage to the electrode, or any constituent parts thereof.

The non-conductive rollers may be provided in a number of different positions along an extent of the flexible electrode. That is to say, the non-conductive body may comprise an array of non-conductive rollers.

A plurality of non-conductive rollers may be coupled, or attached, to each of the conductive body elements. At least four non-conductive rollers are preferably attached to each of the conductive body elements. Each of the four non-conductive rollers may be attached to the respective conductive body element in the following positions (of the conductive body element): radially inner side (close to an end of the element [or joint]); radially outer side (close to an end of the element [or joint]); axially inner sidewall; and axially outer sidewall. At least one non-conductive roller may be provided at each outer side of the conductive body element. The plurality of non-conductive rollers are preferably passive (i.e. non-driven) rollers. The non-conductive rollers may be described as guide rollers.

The plurality of non-conductive rollers may be rotatably coupled to the conductive body elements.

Advantageously, coupling non-conductive rollers to the conductive body elements means that the outer profile of the conductive body elements can be spaced apart from the internal wall. This is advantageous for facilitating electrochemical machining and reducing the risk of arcing (between the conductive body elements and the internal wall). Coupling the non-conductive rollers to the conductive body elements is also advantageous in reducing wear resulting from the interaction between the internal wall and the non-conductive body.

Advantageously, the non-conductive rollers are also an easily replaced component which can be swapped out if required. In particular, disassembly of the electrode is not required beyond simply removing, and replacing, the specific roller, should said roller need to be replaced.

The non-conductive rollers being rotatably coupled is intended to mean that the rollers are fixed to the conductive body elements but are still able to rotate about an axis. The rollers therefore define a roller bearing of sorts. In other words, inserting the electrode into the cavity is facilitated by a rolling action of the non-conductive rollers.

Non-conductive rollers may be coupled to the conductive body elements at a number of different positions around the exterior. For example, when the conductive body elements are generally tubular, having a circular cross-section, non-conductive rollers may be provided at diametrically opposed positions. It will be appreciated that more non-conductive rollers can be incorporated, for example distributed around the exterior of the conductive body elements.

As well as the non-conductive rollers being coupled to the conductive body elements at a number of different positions around a cross-section of the element, a number of non-conductive rollers may also be provided at different positions along a length, or extent, of the conductive body elements. For example, where the conductive body element is generally tubular, diametrically opposed rollers may be provided at a first position along a length of the element, and a further pair may be provided at a second position along at a different length along the conductive body element.

The non-conductive rollers may be rotatably coupled to an exterior of the conductive body elements. Exterior of the conductive body element may refer to an outer profile. However, exterior may also refer to an externally exposed, but recessed, portion of a perimeter of the element. The non-conductive rollers may be provided within a recess, or pocket, defined in the outer profile of the conductive body element. Only a portion of the non-conductive roller may project outwardly beyond the outer profile of the conductive body element, the rest of said non-conductive roller being surrounded by the recess, or pocket, within the outer profile of the conductive body element. In other arrangements, an entirety of the non-conductive roller may project outwardly beyond the outer profile of the conductive body element to which the non-conductive roller is attached.

An outer profile of the plurality of conductive body elements and the plurality of non-conductive rollers may generally taper from a first end of the electrode to a second end of the electrode. That is to say, a cross-sectional area of the outer profile of the first end of the electrode may be larger than a cross-sectional area of the outer profile of the second end of the electrode. Advantageously, this means the electrode, specifically the conductive body elements, can conform to the internal wall of a comparatively tapering cavity, such as a turbomachine housing volute, for example. The tapering may be linear, or nonlinear (i.e. may follow an arcuate profile). The tapering is intended to refer to the outer profile of the conductive body, and non-conductive body, and may exclude the outer profile of the flexible core (which may project beyond the second end of the electrode, and have a comparatively small cross-section).

In use, the conductive body elements may contact one another when conforming to the cavity profile. For example, where the cavity is a volute, the conductive body elements may contact one another when the electrode flexes to conform to the generally spiral geometry of the volute.

The cavity may be a fluid conduit. The cavity may comprise a fluid conduit.

Fluid conduit refers to a cavity (e.g. a passage) through which a fluid flows in use. The fluid may be a liquid (e.g. water or oil) or a gas (e.g. air). Example of fluid conduits include: a turbine housing volute, a compressor housing volute, a pipe within a manifold, and water or oil conduits.

Components which incorporate fluid conduits include manifolds, turbomachine housings, EGR valves and engine blocks.

Manifolds, turbomachine housings, EGR valves and engine blocks are just some examples of components which may incorporate a cavity that can be electrochemical machined using the above defined method. These are also example of components which may incorporate a nonlinear cavity (e.g. incorporating a bend along an extent of the cavity) which is a challenging geometry to electrochemically machine (unless the flexible electrode described herein is utilised). It will be appreciated that a variety of other components, and associated cavity geometries, can be used in combination with the method.

The component, which may be a turbomachine housing such as a turbine housing or compressor housing, may be manufactured from cast iron. The component, which may be a turbine housing or compressor housing, may be manufactured from aluminium. The component, which may be a turbine housing or compressor housing, may be manufactured from stainless steel. The component may be manufactured from an electrically conductive material.

The flexible electrode may extend through at least around 50% of an extent of the fluid conduit.

The flexible electrode extending through to at least around 50% of the extent of the fluid conduit is advantageous in that a significant proportion of the fluid conduit can be machined in the electrode chemical machining process.

The flexible electrode may extend through at least around 80% of the extent of the fluid conduit, or at least around 85% of the extent of the fluid conduit.

The cavity may be a turbine housing volute or compressor housing volute. The cavity may be a volute of a turbomachine housing.

The turbine housing volute may form part of a turbine housing for a turbocharger. The compressor housing volute may form part of a compressor housing for a turbocharger.

A volute has a cross section which changes along an extent, or length, of the volute. That is to say, the volute has a non-constant cross sectional area, or shape taken normal to the length of the volute. This can otherwise be described as generally tapering.

For the compressor housing volute, the cross section may transition from a generally smaller circle to a generally larger circle (moving from the opening to a discharge outlet). For the case of a turbine housing volute, a cross section may transition from a generally larger rectangle to a generally smaller rectangle. It will be appreciated that the shapes are by way of example only, and that a variety of other geometries, including complex cross sectional shapes, may otherwise be incorporated.

For a turbine housing volute, defined by a cross section which extends along an arcuate extent of the volute, a width of the cross section (i.e. a major dimension) may reduce from around 80 mm (proximate a turbine housing inlet) to around 15 mm (distal the turbine housing inlet). A height of the cross section (i.e. a minor dimension) may reduce from around 100 mm (proximate a turbine housing inlet) to around 40 mm (distal a turbine housing inlet). The width of the cross section may be taken in the axial direction. The height of the cross section may be taken in a radial direction.

For a compressor housing volute, the cross-section may be generally circular and a corresponding diameter may reduce from around 100 mm (proximate a compressor housing outlet) to around 15 mm (distal a compressor housing outlet).

An extent, or length, of the volute may be said to be arcuate. That is to say, moving from the opening to an end point, or distal tip, of the volute, the midpoint of the cavity (i.e. a midpoint of the cross section) is generally arcuate. The volute may be said to extend part way around the circumference of a circle. The geometry may otherwise be described as generally snail shell like, or partly spiral. The volute may also extend in a direction out of a plane of the spiral. That is to say, the volute may be spring-like, or partly helical. Put another way, the geometry along the length of the volute may be similar to that if a generally circular ring of flexible material is cut, and the two ends are urged in opposing axial directions.

The volute may be between around 250 mm and around 2000 mm in extent (i.e. length). This may correspond with a housing where the volute centreline is provided at a diameter of between around 150 mm and around 600 mm.

The turbine housing may be a twin volute housing. The turbine housing may be an asymmetric housing.

The flexible electrode may extend through at least around 50% of an extent of the volute.

The flexible electrode extending through to at least around 50% of the extent of the volute is advantageous in that a significant proportion of the volute can be machined in the electrode chemical machining process.

The flexible electrode may extend through at least around 80% of the extent of the volute, or at least around 85% of the extent of the volute.

A distal end of the volute may not be occupied by the electrode in use. The performance benefit gained by electrochemically machining the distal end of the volute may be less than other parts of the volute, so it may be preferable that the distal end of the volute is not electrochemically machined. The electrode may terminate between around 5 and around 25 mm from a distal tip of the volute. The electrode may be said to extend up to, but not including, an end of the volute tail.

In some arrangements, an entire extent of the volute may be occupied by the electrode. That is to say, the electrode may extend through an entire extent of the compressor housing volute or turbine housing volute.

The flexible electrode may be less than between around 250 mm and around 2000 mm in extent (i.e. length).

The flexible electrode may extend through at least around 50% of an extent of the cavity.

The opening may be an inlet of a turbine housing or an outlet of a compressor housing.

The inlet of the turbine housing may be generally tangential. The outlet of the compressor housing may be generally tangential. By inserting the electrode through an opening which is one of these features, the electrode can be inserted through a readily accessible aperture having a geometry which generally decreases moving along an extent of the volute. This is advantageous in being able to insert an electrode, having a corresponding tapering geometry, such that the electrode conforms to the internal cavity along an extent of the electrode and/or cavity.

Inserting the electrode through a feature other than those mentioned may be difficult in the case of a turbomachine housing, owing to the space constraints and clearances that the electrode would have to navigate through.

Electrolyte may be provided (e.g. pumped) through the opening and discharged through an outlet of the turbine housing or an inlet of a compressor housing respectively.

Pumping electrolyte through the opening, the opening being an inlet of a turbine housing or an outlet of a compressor housing, provides a convenient means of connecting the volute to an electrolyte source. As mentioned above, these features are readily accessible from an exterior of the component. Discharging the electrolyte via an outlet of the turbine housing, or an inlet of the compressor housing, these features being generally axial, also provides a convenient way of discharging the electrolyte flow. The discharge electrolyte flow, i.e. the electrolyte flow downstream of the conductive body, comprises pieces of machined material. As well as facilitating the electrochemical machining process, the electrolyte also transports machined material out of the component. Machined material may be in the form of fine particle hydroxides, which are diluted into the electrolyte. The electrolyte may be filtered continuously, as part of the process, so as to remove the particles from the electrolyte (before the electrolyte is recirculated). The electrolyte may be cooled as part of the recirculating process. The electrolyte may dissipate heat generated by the electrochemical machining process.

It will be appreciated that the direction of electrolyte flow could also be reversed e.g. for a turbine housing, electrolyte may be pumped in via the turbine housing outlet and discharged via the turbine housing inlet. More specifically, the electrolyte may be pumped in via a turbine inducer gap.

The cavity may be a first of a plurality of cavities, and the flexible electrode may be a first of a plurality of flexible electrodes; and wherein a respective one of the plurality of flexible electrodes may be received in each of the plurality of cavities.

Advantageously, having a flexible electrode provided in each of a plurality of cavities means that volutes of a twin volute turbine housing, for example, can be machined using the electrochemical machining process. Providing a flexible electrode in each volute ensures that each volute is machined to a desirable standard, whilst still enabling the process to be used despite the challenging geometry presented by a twin volute turbine housing (for example).

Twin volute turbine housing is intended to mean a turbine housing having a pair of discrete volutes, having an associated cross sectional area, which may converge to form a single volute at some point along an extent of the volutes. The twin volute turbine housing may be an asymmetric or symmetric twin volute arrangement.

According to a second aspect of the disclosure there is provided a flexible electrode for electrochemically machining a cavity of a component, the electrode comprising:
a) a flexible core;
b) a conductive body electrically coupled to the core; and
c) a non-conductive body.

At least part of an outer profile of the non-conductive body may be configured to engage an internal wall of the cavity.

The electrode may comprise a plurality of non-conductive bodies.

The non-conductive bodies may comprise non-conductive plates.

The electrode may comprise a plurality of conductive bodies.

The conductive bodies may comprise conductive plates.

The plurality of conductive plates may interpose the plurality of non-conductive plates.

An outer profile of the plurality of conductive plates and the plurality of non-conductive plates may generally taper from a first end of the electrode to a second end of the electrode.

Tapering is intended to mean that an outer profile of the overall electrode generally reduces moving from the first end to the second end of the electrode. The tapering may otherwise be described as the cross-sectional area reducing in magnitude, or the cross-sectional area of the electrode reducing along a length of the electrode. Advantageously, this facilitates the use of the electrode with a correspondingly tapering cavity, such as a volute of a turbomachine housing. Specifically, the conductive body can still be exposed to the internal wall, separated by a desired amount, despite the geometry of the volute.

The tapering may be linear or nonlinear.

The conductive bodies may comprise conductive body elements.

The non-conductive bodies may comprise non-conductive rollers.

The plurality of non-conductive rollers may be rotatably coupled to the conductive body elements.

An outer profile of the plurality of conductive body elements and the plurality of non-conductive rollers may generally taper from a first end of the electrode to a second end of the electrode.

According to a third aspect of the disclosure there is provided an electrode arrangement comprising a plurality of electrodes according to the second aspect of the disclosure.

According to a fourth aspect of the disclosure there is provided a component comprising a cavity electrochemically machined using the method according to the first aspect of the disclosure and/or using the electrode according to the second aspect of the disclosure.

According to a fifth aspect of the disclosure there is provided a method of electrochemically machining a volute of a turbomachine housing.

The optional and/or preferred features for each aspect of the disclosure set out herein are also applicable to any other aspects of the disclosure, where appropriate.

### BRIEF DESCRIPTION OF THE DRAWINGS

Embodiments of the present disclosure will now be described, by way of example only, with reference to the accompanying drawings, in which:

FIG. 1 schematically depicts a known electrochemical machining process;

FIG. 2 schematically depicts a flexible electrode according to an embodiment of the disclosure;

FIG. 3a is a schematic illustration of an end-on cross section view of a turbine housing, with the flexible electrode of FIG. 2 inserted in a volute thereof;

FIG. 3b is a cross section side view of the turbine housing and flexible electrode of FIG. 3a;

FIG. 3c shows the cross section view of FIG. 3a, with electrolyte flow direction indicated in an opposite direction;

FIG. 4 is a cross section side view of a turbine housing with two flexible electrodes inserted in volutes thereof, according to another embodiment;

FIG. 5 is a cross section side view of a compressor housing with another embodiment of flexible electrode inserted in a volute thereof;

FIG. 6 is a cross section side view of a turbine housing with a flexible electrode according to a further embodiment inserted in a volute thereof;

FIG. 7 is a schematic cross section view of a volute, in isolation of the rest of the turbine housing, with an electrode, according to a further embodiment, inserted therein;

FIG. 8 is a schematic cross section view of a volute, in isolation of most of the rest of the turbine housing, with an electrode, according to a further embodiment, inserted therein; and

FIG. 9 is a schematic cross section view of part of a volute, in isolation of the rest of the turbine housing, with an electrode, according to a further embodiment, inserted therein.

### DETAILED DESCRIPTION

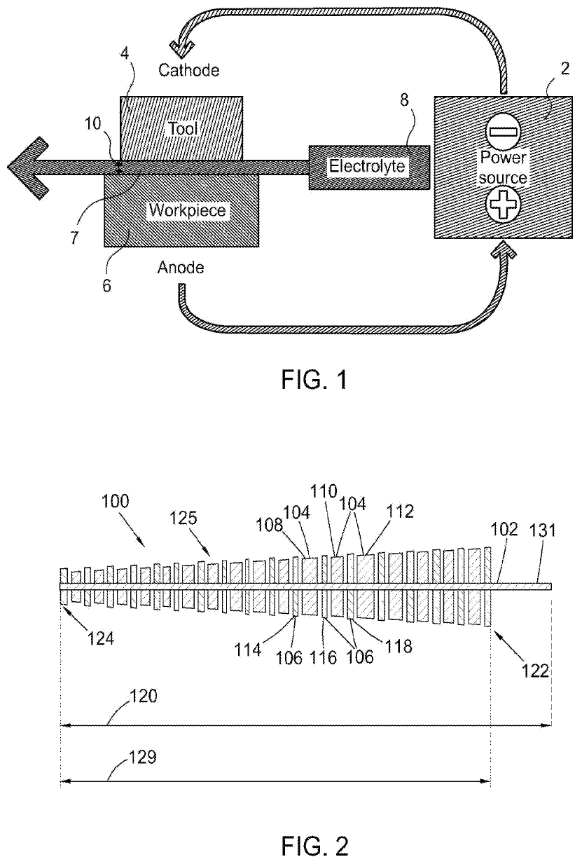

Beginning with FIG. 1, a known electrochemical machining process is schematically illustrated.

A power source 2, which may be a DC power source, is used to apply a negative charge to an electrode 4. This may be by virtue of the electrode 4 being electrically connected to a negative terminal of the power source 2. The electrode 4 therefore forms a cathode. The power source is preferably a DC power supply.

A positive charge is effectively applied to a component 6, which is to be machined, by electrically connecting the component 6 to a positive terminal of the power source 2 or, alternatively, by connecting the component 6 to ground (i.e. grounding the component). Given that the component 6 is more positively charged than the electrode 4, the component forms an anode.

A gap 10 is provided between the electrode 4 and the component 6. Specifically, the gap 10 is provided between the electrode 4 and an electrode facing surface 6a, or exposed surface, of the component 6. The gap 10 may otherwise be referred to as a clearance.

A flow of electrolyte 8 is pumped through the gap 10 between the electrode 4 and the component 6 (specifically the electrode facing surface 6a thereof). The electrolyte flow 8 effectively completes the circuit, owing to the electrolyte being conductive. As electrons flow across the gap 10, material from an electrode facing surface 6a of the component 6 is dissolved, or removed. It will also be appreciated that material will be removed from the electrode facing surface 6a in a manner which generally conforms to the electrode 4 geometry. The electrolyte 8 then transports the removed material downstream of the component 6 and electrode 4.

Electrochemical machining may otherwise be referred to as reverse electroplating in that material is removed, rather than being added (as is the case for electroplating). The polarity of the electrode and workpiece may also be reversed in comparison to electroplating.

The electrodes used in existing processes limit the geometries that can be machined by electrochemical machining. Specifically, given that the electrode 4 is in facing relations with the electrode facing surface 6a of the component 6, and that a gap 10 is present in order for the electrolyte flow 8 to pass through, prior art methods and apparatuses may be unsuitable for use with more complex component geometries.

FIG. 2 schematically depicts an electrode 100 in accordance with an embodiment of the disclosure. FIG. 2 is a top down view of the electrode 100.

The electrode 100 comprises a flexible core 102, a conductive body 104 and a non-conductive body 106. The flexible core 102 may be a wire, or braided wire.

In the illustrated embodiment, the conductive body 104 comprises a plurality of conductive bodies in the form of conductive plates 108, 110, 112 (only some of which are labelled in the Figure). Similarly, the non-conductive body 106 comprises a plurality of non-conductive bodies in the form of non-conductive plates 114, 116, 118 (again, only some of which are labelled in FIG. 2).

It will be appreciated from FIG. 2 that the flexible core 102 defines an extent, or length, of the electrode 100. The extent, or length, of the electrode 100 is indicated 120 in FIG. 2.

Each of the plurality of conductive plates 108, 110, 112, and plurality of non-conductive plates 114, 116, 118, are attached to the flexible core 102. The conductive body 104 (comprising conductive plates 108, 110, 112) is therefore electrically coupled to the core 102. That is to say, the conductive body 104 is electrically connected to the flexible core 102. The conductive body 104 is so called because it is electrically conductive in that electrons are readily able to travel through the conductive body 104. In contrast, the non-conductive body 106 is so called because electrons are generally unable to travel thereacross. The non-conductive body 106 may be made of one or more of a ceramic or plastic, for example. Nylon may be a preferred material. The conductive body 104 may be made of metal, or another electrically conductive material. Stainless steel has been found to be particularly effective. This is due to the resilience of stainless steel to corrosion. The conductive body 104 may be made from a 300/400 series steel. 300 series steel has been found to be effective at resisting corrosion due to exposure to salt water.

The non-conductive plates 114, 116, 118 of the non-conductive body 106 interpose the conductive plates 108, 110, 112 of the conductive body 108. That is to say, there is an alternating pattern of conductive plate and non-conductive plate along the electrode 100. Furthermore, the flexible core 102 passes through the centre of all of the conductive body 104 and non-conductive body 106 (i.e. each of the conductive plates 108, 110, 112 and non-conductive plates 114, 116, 118).

In use, and as will be appreciated from subsequent Figures, the electrode 100 is inserted into a cavity via an opening. The flexible core 102 elastically deforms, or bends, to generally conform to the cavity (and specifically to a direction along which a cross-section of the cavity extends, or a direction along the length of the cavity). A clearance, or gap, which is provided between adjacent conductive and non-conductive plates facilitates the flexing of the electrode 100. In use, the non-conductive body 106 (specifically the non-conductive plates 114, 116, 118) engages, or contacts, an internal wall of the cavity. The conductive body 104 (specifically conductive plates 108, 110, 112) is spaced apart from the internal wall such that a clearance, or gap, exists between the conductive body 104 and the internal wall. This provides an equivalent feature to the gap 10, described in connection with FIG. 1, through which electrolyte can be pumped, and across which electrons travel, to remove material from the internal wall in the electrochemical machining process.

An outer profile of the conductive and non-conductive bodies 104, 106 is tapered. That is to say, a cross section at a first end 122 of the bodies 104, 106 is larger than a cross section of the bodies 104, 106 at an opposing, distal second end 124. This tapering arrangement means that the electrode 100 can be readily received in a similarly tapering cavity, such as a volute of a turbomachine housing.

The portion of the electrode 100 which is occupied by the conductive body 104 and non-conductive body 106 may be referred to as a body portion 125 of the electrode. The bodies may be said to extend from the first end 122 of the body portion 125 to the second end 124 of the body portion 125. The length, or extent, of the body portion 125 is labelled 129 in FIG. 2.

In use, an exposed end 131 of the flexible core 102 is connected to a power supply, such as the power supply 2 shown in FIG. 1. A negative charge is applied to the electrode 100, and specifically to the flexible core 102 thereof. By virtue of the electrical connection between the flexible core 102 and the conductive body 104 (comprising conductive plates 108, 110, 112) the negative charge is also applied to the conductive body 104. For reasons previously mentioned, this facilitates the electrochemical machining process of the cavity in which the electrode 100 is inserted.

The plates 108, 110, 112 of the conductive body 104, and/or the plates 114, 116, 118 of the non-conductive body 106, may have any one of a number of different cross sectional shapes. For example, the plates may be circular in cross section, or rectangular. Each of the plurality of non-conductive plates 108, 110, 112 may have the same cross sectional geometry as the plates 108, 110, 112 of the conductive body 104, but generally reduce in size, or magnitude, moving from the first end 122 towards the second end 124. This is to create the tapering external geometry, or outer profile, of the electrode 100. Similarly, the cross section of the plates 108, 110, 112 of the conductive body 104 may be generally smaller than adjacent plates 114, 116, 118 of the non-conductive body 106. This may be to facilitate the gap between an outer profile of the conductive body 104 and the internal wall to be machined. Put another way, the outer profile of the non-conductive body 106 projects outwardly beyond the outer profile of the conductive body 104.

Although the described electrode 100 is a flexible electrode, in other arrangements the electrode may not be flexible. That is to say, the core of the electrode may not be flexible and, instead, the electrode may only be insertable along a cavity which has a linear geometry (e.g. it does not bend along its extent).

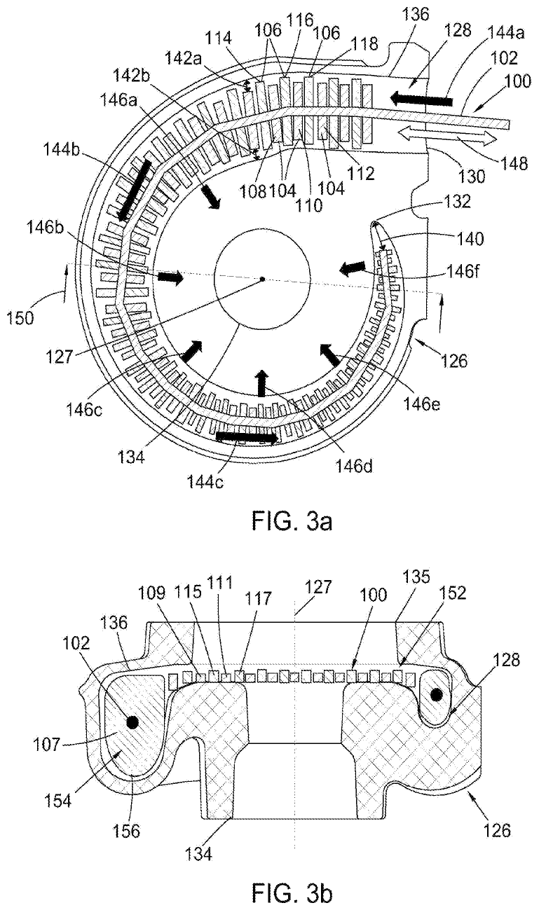

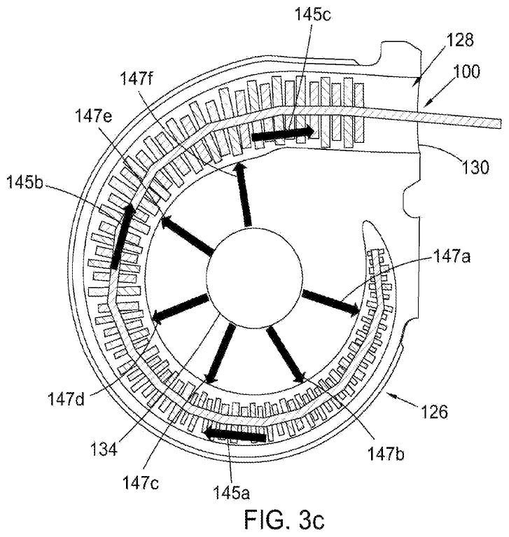

FIG. 3a is an end-on cross section view of a turbine housing 126, with the electrode 100 inserted in a volute 128 thereof. The cross section of FIG. 3a is taken through a plane that extends through the volute 128, and the view is in a direction facing away from the bearing housing (not shown, where the turbine housing forms part of a turbocharger).

As indicated in FIG. 3a, the turbine housing 126 comprises the volute 128. The volute 128 is the cavity which is to be electrochemically machined. The volute 128 is defined by an opening 130. The opening 130 is (in the illustrated embodiment) in the form of a generally circular aperture which is generally tangential to a central axis 127 of the turbine housing 126. In other embodiments the opening may have another shape, for example triangular, square, rectangular etc. A turbine wheel (not shown in FIG. 3a) rotates about the central axis 127 in use.

Returning to the volute 128, a distal tip of the volute 128 is indicated 132 in FIG. 3a. Although the distal tip 132 appears to be a rounded, closed end of the volute 128, as will be described in connection with FIG. 3b, a radial passage extends around the central axis 127 and between the volute 128 and the turbine housing outlet 134. The turbine housing outlet 134 extends axially along the central axis 127, and takes the form of a generally circular aperture (at a downstream end of a tubular annular passageway).

The volute 128 is also defined by an internal wall 136 which extends along an extent of the volute 128. The extent of the volute 128 is intended to mean a length along which the volute 128 extends (i.e. as shown in FIG. 3a it corresponds with the length from the opening 130 to the tip 132 if the volute 128 was to be uncurled in a straight line).

As will be appreciated from FIG. 3a, the electrode 100 of FIG. 2 is shown in situ having been inserted through the opening 130 and along volute 128. The electrode 100 occupies a majority of the extent of the volute 128. The electrode 100 may occupy, for example at least 85% of an extent of the volute 128. It will be appreciated that the electrode 100 may not occupy an entire extent of the volute 128. That is to say, there may be a portion of an extent of the volute 128 that the electrode 100 does not occupy. This may be referred to as a vacant, or unoccupied, extent, and is labelled 140 in FIG. 3a.

In use, the electrode 100 is inserted through the opening 130. As discussed in connection with FIG. 2, an outer profile of the non-conductive body 106 engages the internal wall 136 of the volute 128. Also as described in connection with FIG. 2, the non-conductive body 106 comprises the plurality of non-conductive plates 114, 116, 118. Because an outer profile of the non-conductive plates 114, 116, 118 projects outwardly beyond an outer profile of the adjacent plurality of conductive plates 108, 110, 112, the electrode 100 is effectively suspended within the volute 128 by the plurality of non-conductive plates 114, 116, 118. Furthermore, there is a radial clearance, or gap, provided between an outer profile of the plurality of conductive plates 108, 110, 112 and the internal wall 136. The gap is indicated schematically and is labelled 142a, 142b in FIG. 3a. The gaps 142a, 142b provided between the conductive body 104 and the internal wall 136 are equivalent to the gap 10 indicated and described in connection with FIG. 1. That is to say, it is a gap through which electrolyte is passed to complete the electrical circuit, and to facilitate the removal of material from the internal wall 136 by electrochemical machining.

In the illustrated example, the non-conductive plates 114, 116, 118 have substantially the same cross section geometry as adjacent conductive plates 108, 110, 112 but are around 0.3 mm larger, on radius. The non-conductive plates 114, 116, 118 contact the internal wall 136 and the reduced cross section of the conductive plates 108, 110, 118 provides the gap 142a, 142b between the conductive plates 108, 110, 112 and the internal wall 136. Contact between the conductive plates 108, 110, 112 and the internal wall 136 is undesirable because such contact can lead to a short circuit, which is disruptive to the process and risks damage to equipment and/or components. Said short circuit could lead to the electrode effectively being welded to the wall of the component.

In use, as the electrode 100 is inserted into the volute 128 via the opening 130, it will be appreciated that the flexible core 102 elastically deforms, or flexes, to generally conform to the volute 128. Specifically, flexible core 102 is urged to flex by virtue of the engagement between the non-conductive plates 114, 116, 118 and the internal wall 136. Gaps between adjacent plates (i.e. conductive and non-conductive) facilitate the flexing, or bending, of the flexible core 102.

It has been found to be advantageous to have an outer profile of the conductive body 104 be between around 0.5 mm and around 1 mm smaller than a comparative outer profile of the non-conductive body 106 (e.g. adjacent plates). Similarly, it is found to be advantageous to have an outer profile of the conductive body 104 be between around 0.3 mm and around 2.5 mm smaller in magnitude than a profile (i.e. cross section geometry) of the volute 128. That is to say, a gap of between 0.3 mm and around 2.5 mm preferably exists between the conductive body 104 and internal wall 136. The gap may be even larger in some embodiments, for example up to around 20 mm. The gap, between an outer profile of the conductive body 104 and the internal wall 136, may be between around 0.3 mm and around 20 mm. Preferably, the conductive body 104 outer profile lies between around 1.1 mm and around 1.6 mm within the profile of the volute 128. Put another way, the conductive body 104 outer profile is recessed within the profile of the volute 128 by between around 1.1 mm and around 1.6 mm. That is to say, a gap of between 1.1 mm and around 1.6 mm preferably exists between the conductive body 104 and internal wall 136. It has been found that there is a balance to be struck between the aforementioned gap, the power applied and a concentration of the electrolyte salt. For example, the gap can be increased (i.e. a smaller electrode used) if this is compensated for by increasing the power applied and/or the concentration of electrolyte salt. The gap may be referred to as a working gap. The concentration of electrolyte may be up to around 20% by volume.

FIG. 3a indicates that, although the volute 128 is said to be electrochemically machined, a ‘starting’ volute geometry is present before the electrode 100 is inserted. Typically, the starting volute geometry is present by virtue of cores which are inserted in a mould before the turbine housing 126 is, for example, is cast. This generally creates the volute geometry and may be referred to as a cast volute or cast volute geometry. However, the internal wall of said cast volute geometry has a relatively high surface roughness which is undesirable for certain applications where fluid flow is disrupted by a relatively high surface roughness (e.g. a volute of a turbomachine housing). The cast geometries are therefore polished in order to improve the surface finish, by reducing the surface roughness. The polishing therefore refers to a process which occurs after an initial cavity geometry has been created, which improves the surface finish by removing a small amount of material from an internal profile thereof. It may be used to remove imperfections such as welded joints and also to polish tubular internal passages on, for example, exhaust systems and other products. The electrochemical machining described in connection with this document can therefore be said to be a polishing, or finishing, process, rather than a process in which the volute is first created (in, for example, a solid body).

Turning to describe the process specifically, as previously mentioned an initial volute geometry is created by virtue of a casting process, for example. Said volute may be described as a cast volute. The cast volute has a surface roughness which is undesirably high for some applications. The electrode 100 is inserted into the volute 128 through the opening 130. A flow of electrolyte is then pumped through the opening 130, the opening 130 therefore constituting an electrolyte flow inlet. The electrolyte flows at least part way through the volute 128, passing through the gaps (e.g. 142a, 142b) between the conductive body 104 outer profiles and the internal wall 136. The electrolyte also flows through small gaps between the outer profile of the non-conductive body 106 and the internal wall 136. This is, at least in part, owing to there being a significant volume of electrolyte pumped through the volute 128 whilst the electrochemical machining process is carried out. The flow of electrolyte through the volute is indicated by arrows 144a-c. It will be appreciated that not all of the electrolyte passes around an entire, or even a majority, of the extent of the volute 128. Instead, a portion of the electrolyte will flow radially inwardly as indicated by arrows 146a-f. That is to say, after flowing around the volute 128 to whatever circumferential extent the electrolyte flow reaches, the electrolyte flow then passes radially inwardly via the radial passage (not visible in FIG. 3a, but labelled 152 in FIG. 3b). Returning to FIG. 3a, finally, the electrolyte is discharged through the turbine housing outlet 134.

Although in the above-described arrangement the electrolyte flow direction is indicated by arrows 144a-c and 146a-f, entering the volute 128 via the opening 130 and leaving (or being discharged) via turbine housing outlet 134, the flow direction may be reversed in other arrangements. That is to say, the electrolyte flow may be pumped against arrows 144a-c and 146a-f, entering via the turbine housing outlet 134 and exiting the volute 128 via the opening 130. Such flow direction is schematically indicated in FIG. 3c.

In FIG. 3c, the electrolyte flow direction is indicated by arrows 147a-f, and 145a-c. The opening 130 may be referred to as a turbine housing inlet. The electrolyte flow may exit, or enter, the volute 128 specifically via the radial passage 152 (visible in FIG. 3b). The radial passage 152 may be referred to as a turbine inducer gap.

With the electrode 100 inserted in place, and with the electrolyte flow activated, an associated power supply, connected to the electrode 100, is activated. Activation of the power supply applies a negative charge to the electrode 100, specifically the flexible core 102 and, by virtue of the electrical connection, the conductive body 104 (comprising the plurality of conductive plates 108, 110, 112). The turbine housing 126 effectively has a positive charge applied to it by virtue of being grounded to earth or by being connected to the positive terminal of the aforementioned power supply. The process briefly described in connection with FIG. 1, in relation to electrochemical machining, then occurs as previously described. Specifically, the conductive plates 108, 110, 112 form the cathode, and the internal wall 136 of the volute 128 forms the anode. The gaps 142a, 142b (between the conductive plates 108, 110, 112 and the internal wall 136) reduce the risk of arcing, or short circuiting, occurring between the conductive body 104 and the internal wall 136, and also facilitate the electrochemical machining of the internal wall 136. The electrolyte flow completes the circuit and, as electrons pass across the electrolyte and are absorbed by the internal wall 136, material is removed from, or vaporised from, the internal wall. The electrolyte flow transports any material, which is removed from the internal wall 136, discharging the waste material through the turbine housing outlet 134. The removed material may be referred to as stripped metal.

The power supply may provide around 140 A at around 20 V. The power supply may be activated for around 90 seconds. The power supply may provide up to around 1 kA at around 20V. It will be appreciated that there is a tradeoff between the power used, time taken to conduct the machining and the quality of the machined product (specifically the surface roughness thereof). The power supply may provide around 1500A at around 40V (i.e. a 60 kW power supply). The power supply may provide around 2500A at around 40V (i.e. a 100 kW power supply).

Electromechanical machining can be used to achieve a surface finish which is equivalent to a polished standard. The process may only take a few minutes and is readily applicable to a wide variety of cavity geometries.

To further improve the surface finish, the electrode 100 may be reciprocated within the volute 128. This is indicated schematically by the arrow 148. The reciprocation is intended to mean that the electrode is urged in alternating directions within the volute 128. Advantageously, reciprocation of the electrode 100 ensures a greater proportion of the internal wall 136 is machined by the electrochemical machining process. This is because an outer profile of the conductive plates 108, 110, 112 is exposed to a greater extent, or length, of the internal wall 136 of the volute 128 when the electrode 100 is reciprocated. Electrode 100 may be reciprocated by between around 5 mm and around 10 mm. It will be appreciated that the reciprocation may occur before the power supply is activated, or after the power supply is activated.

The aforementioned process is advantageous for a number of reasons. It provides a fast and low cost method for polishing (i.e. improving the surface finish) of volutes and other complex cavities (i.e. cavities incorporating one or more bends, having a generally non-linear extent). The improved surface finish provides improved turbine, compressor and overall turbocharger efficiencies when used on a turbine housing or compressor housing which forms part of a turbocharger. More generally, the improved surface finish reduces losses in any flow moving through such a cavity, increasing the efficiency of any such component. Part variation, i.e. tolerances, are also reduced. A sand cast finish, which may have a surface roughness of 6-18 μm (micrometres) Ra can be improved and the surface finish reduced to between 0.5-5 μm Ra using electrochemical machining. Furthermore, a standalone, or portable, electrochemical machining apparatus can be used at a foundry, machine shop or even at a supplier if required. The method therefore provides a flexible process which can be used at various points throughout the supply chain. As well as being used to improve the surface finish of the wall of the cavity, the method may be used to improve/control the tolerance of the cavity itself.

For reference, a sandcasted finish of a volute may be able to achieve a surface finish of 9-18 μm Ra, and finer sand grades may improve it to a surface finish of 6-9 μm Ra. Electrochemical machining, in accordance with the process described above, can achieve a surface finish of less than 1 μm Ra, and incorporating a flexible electrode as described above facilitates the use of such a process with a complex cavity geometry such as a turbomachine housing volute. With that said, the process can be applied to a wide range of complex (and simple) geometries, and components, such as EGR valves, manifolds and other components incorporating cavities.

Turning to FIG. 3b, an alternative cross section view of the turbine housing 126, with the electrode 100 inserted in the volute 128 thereof, is provided. The cross section view of FIG. 3b is as indicated by the cross section marker 150 in FIG. 3a.

FIG. 3b shows the volute 128 extending around the central axis 127 and also illustrates the cross sectional shape of the internal wall 136. The radial passage extending between volute 128 and the turbine housing outlet 134 is also indicated and labelled 152. It will be appreciated that the electrode 100 is shown in situ and therefore occupying the radial passage 152.

Of relevance in FIG. 3b, the left hand side shows a non-conductive plate 107, which forms part of the non-conductive body 106. The flexible core 102 can be seen extending through the non-conductive plate 107, along with all of the other plates forming part of the electrode 100. The non-conductive plate 107 has a cross section 154 that is defined by an outer profile 156. The outer profile 156 generally conforms to the internal wall 136. That is to say, the geometry, or shape, of the non-conductive plate 107, and other non-conductive plates, generally matches, or fits to, a corresponding region of the internal wall 136 that defines the volute 128. In use, the outer profile 156 generally contacts the internal wall 136, and FIG. 3b is therefore merely a schematic illustration to show the placement of the electrode 100 in the volute 128.

It will be appreciated that, in practice, the outer profile 156 is slightly smaller than a corresponding profile of the internal wall 136 to facilitate the insertion of the electrode 100 into the volute 128. Once the electrode 100 is positioned within the volute 128, at least some of the outer profile 156, of the non-conductive plate 107 (for example), contacts the internal wall 136. Whilst only described in connection with a single non-conductive plate 107, it will be appreciated that the above is generally applicable to all of the non-conductive plates and the corresponding regions of the internal wall 136 which the plate aligns with.

Also indicated in FIG. 3b are further non-conductive plates 115, 117 and adjacent conductive plates 109, 111. It will be appreciated that the outer profile of the non-conductive plates 115, 117 projects outwardly beyond the profile of the conductive plates 109, 111.

As will be appreciated from FIG. 3b, the geometry of the plates is generally rectangular, with rounded corners. However, many other geometries are possible depending upon the cross section shape of the cavity in question. For example, if rather than a turbine housing 206 a compressor housing was instead the component in question, a cross section of the plates may be generally circular. This will be described in more detail in connection with FIG. 5, later in this document.

Briefly returning to FIG. 3b, it will be appreciated that if the electrolyte was pumped in via the opening 130 (not shown in FIG. 3b, but visible in FIG. 3a), the electrolyte would be discharged via both the turbine housing outlet 134 and via a further opening 135 which generally opposes the turbine housing outlet 134. The further opening 135 is an aperture which is penetrated by a turbine wheel (at least during the assembly process) which is connected to a bearing housing (to which the turbine housing 126 is also connected). The further opening 135 may be referred to as a bearing housing location diameter. When electrochemical machining is carried out, it is desirable to plug the further opening 135 to prevent electrolyte from discharging through it. To achieve this, the turbine housing 126 may be mounted to a fixture (e.g. a jig, or mount), which locates and seals the further opening 135, whilst the electrochemical machining process is undertaken. Electrolyte may therefore be unable to discharge through the further opening 135. It is advantageous to locate the turbine housing 126 on the fixture using the further opening 135 because bearing housings are typically generic for a given platform of turbocharger. There are therefore fewer tooling variants for bearing housings than there are turbine housings. This means that the single fixture can be used with a wider range of turbine housings 126 than if the turbine housing 126 was located on the fixture using the turbine housing outlet 134 (for example).

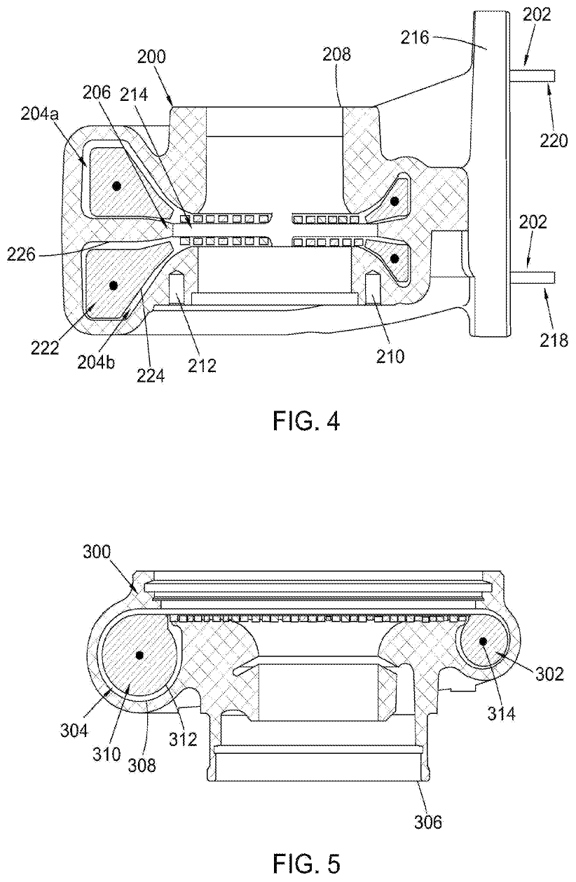

FIG. 4 is a cross section view of a different turbine housing 200 that incorporates a twin volute arrangement (and which may be referred to as a twin volute housing). A twin electrode arrangement 202 is also shown in FIG. 4. Reference numerals that related to features common to both the previous embodiment and the present embodiment will be incremented by 100 and not described in detail.

The primary difference between the twin volute turbine housing 200 of FIG. 4 in comparison to the single volute turbine housing 126 of FIGS. 3a and 3b is that there are two volutes, rather than a single volute. As such, the turbine housing 200 comprises a plurality of volutes 204a, 204b. The turbine housing may be dual entry or twin entry (as shown in FIG. 4). Dual entry refers to a turbine housing which has two volutes, exhaust gas enters via two openings, and there are two tongues in the housing (such that exhaust gas impinges the turbine wheel at two different circumferential locations). The turbine housing may be an asymmetric turbine housing in which there are two volutes, and two openings, but the volutes have different cross-sectional areas. As will be appreciated from FIG. 4, the volutes 204a, 204b are at least partly separated by a tongue 206.

The turbine housing 200 comprises a turbine housing outlet 208, which is generally similar to the outlet described in connection with the previous embodiment. Also visible in FIG. 4 are bores 210, 212 which are configured to receive fasteners to attach the turbine housing 200 to a bearing housing (not shown) to define part of a turbocharger.

The volutes 204a, 204b are defined by respective openings (not visible in FIG. 4) defined in a connection flange 216. The volutes 204a, 204b open out into a radial passage 214 and are in fluid communication with the turbine housing outlet 208.

The twin electrode arrangement 202 comprises first and second electrodes 218, 220. In use, each of the electrodes 218, 220 are inserted into a respective volute 204a, 204b via an associated opening. As described in detail in connection with FIGS. 3a and 3b, the electrodes 218, 220 are flexible and bend, or flex, to conform to the generally spiral geometry of the volutes 204a, 204b. The manner in which this occurs, by virtue of non-conductive plates engaging an internal wall of each of the volutes 204a, 204b is the same as described in connection with FIGS. 3a and 3b, and will therefore not be described in detail in connection with FIG. 4.

A minor difference between the arrangements of FIGS. 3a, 3b and FIG. 4 is that the shape, and so outer profile, of the plates is different. As indicated in FIG. 4, one such (non-conductive) plate being labelled 222, has an outer profile 224 which is generally trapezoidal i.e. it generally has four sides, two of which are parallel with one another. It will be appreciated that the outer profile 224 of the plate 222 generally conforms to an internal wall 226 geometry of the associated volute 204b. As previously described, a range of different cross section shapes, and so outer profile geometries, can be used.

It will also be appreciated that each of the electrodes 218, 220 comprise an associated flexible core, conductive body (comprising a plurality of conductive plates) and a non-conductive body (comprising a plurality of non-conductive plates). Other than for the different outer profiles, the arrangement of the plates along the flexible cores is the same as that indicated in FIGS. 3a and 3b.

It will be appreciated that the twin electrode arrangement 202 provides a convenient means of electrochemical machining the internal walls of a twin volute turbine housing 200, such as that shown in FIG. 4. The electrodes 218, 202 can be inserted through respective openings together, and connected up to a common circuit. The volutes 204a, 204b can therefore be electrochemically machined simultaneously, which is desirable for efficiency reasons. The features described in connection with the previous embodiments are equally applicable to the embodiment shown in FIG. 4.

FIG. 5 is a cross section side view of a compressor housing 300 with an electrode 302 provided in a volute 304 thereof. The compressor housing 300 defines a compressor inlet 306, which is also the aperture which electrolyte is discharged out of in use.

FIG. 5 demonstrates how the electrode 302 can also be used to electrochemically machine an internal wall 308 of the volute 304 in a compressor housing. The volute 304 is defined by the internal wall 308, which extends in a similar manner to that described in connection with the previous embodiments. One difference with the FIG. 5 embodiment is that the cross section of the volute 304 is generally circular, as is typical with volute geometries for a compressor housing. The outer profiles of the conductive and non-conductive plates are therefore also generally circular. Save for the difference in outer profiles of the conductive, and non-conductive plates, the electrode 302 shown in FIG. 5 is substantially identical to the electrode 100 described in connection with FIGS. 2, 3a and 3b.

The electrode 302 shown in FIG. 5 comprises a non-conductive plate 310 having an outer profile 312 which generally conforms to the internal wall 308 of the volute 304. A flexible core 314 is also depicted extending through the electrode 302 and provided centrally through the conductive, and non-conductive, plates.

The compressor housing 300 may be manufactured from aluminium, cast iron, stainless steel or another material.

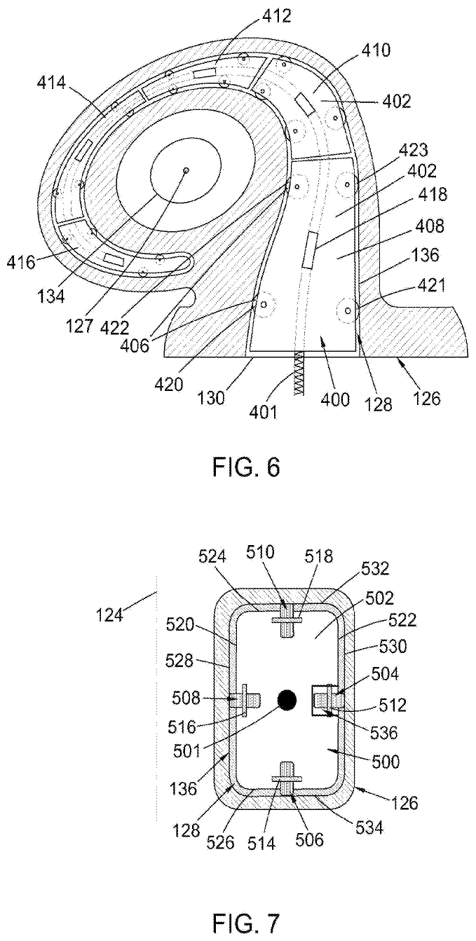

FIG. 6 is a cross section end-on view of the turbine housing 126, as shown in FIGS. 3a and 3b, with an electrode 400 according to a further embodiment inserted in the volute 128 thereof.

Like the electrodes described in connection with the previous Figures, the electrode 400 comprises a flexible core 401. The electrode 400 further comprises a plurality of conductive bodies (two of which are labelled 402) and a plurality of non-conductive bodies (two of which are labelled 406).

The plurality of conductive bodies comprises a plurality of conductive body elements 408, 410, 412, 414, 416. Each of the conductive body elements is electrically coupled to the flexible core 401. This may be directly (i.e. the conductive body elements 408, 410, 412, 414, 416 may be directly connected to the flexible core 401) or indirectly (i.e. one or more components may interpose the conductive body elements 408, 410, 412, 414, 416 and the flexible core 401—such as another conductive body element).

The conductive body elements 408, 410, 412, 414, 416 are generally elongate in that they have a length which has a greater extent than an extent of their cross sectional shape, or profile. Put another way, they may have a length which is greater than their diameter. The conductive body elements 408, 410, 412, 414, 416 may be said to be generally tubular, or frustroconical i.e. sides extending between end faces may be tapered. In the illustrated embodiment, the electrode 400 comprises five conductive body elements 408, 410, 412, 414, 416, but this may be different in other arrangements. For example, fewer than 4, or fewer than 8 conductive body elements may otherwise be incorporated.

As illustrated in FIG. 6, each of the conductive body elements 408, 410, 412, 414, 416 is clamped to the flexible core 401. As will be described only in connection with a first conductive body element 408, the electrical core 402 is passed through a channel 418 which forms part of the conductive body element 408. The flexible core 401 can then be secured within the channel 418 by a clamping means, such as a screw, or some alternative fixing means. This method of fixation is advantageous in still allowing a degree of freedom of movement of the conductive body element 408 relative to the flexible core 401, whilst ensuring the two components remain in electrical communication with one another. It will be appreciated that the other conductive body elements 408, 410, 412, 414, 416 may be attached to the flexible core 401 in the same manner.

In use, and in a similar manner to that described in connection with the earlier embodiments, a gap provided between an outer profile of the conductive body elements 408, 410, 412, 414, 416 and the internal wall 136, which defines the volute 128, facilitates the electrochemical machining of the internal wall 136.

Moving to describe the plurality of non-conductive bodies 406, the plurality of non-conductive bodies 406 comprises a plurality of non-conductive rollers 420, 422 (only some of which are labelled in FIG. 6). The non-conductive rollers 420, 422 are rotatably coupled to an exterior of the conductive body elements 408, 410, 412, 414, 416 (although the specifically identified rollers 420, 422 are attached to an exterior of the first conductive body element 408 only). Only two of the rollers 420, 422, which are rotatably coupled to an exterior of the first conductive body element 408, will be described in detail.

Rotatably coupled to an exterior of the conductive body element 408 is intended to mean that the non-conductive rollers 420, 422 are attached to the exterior but are still able to rotate. That is to say, they are able to roll, in a similar manner to a roller bearing. Advantageously, this means that the electrode 400 can be readily inserted into the volute 128, and urged therethrough. The incorporation of non-conductive rollers also reduces the wear of the non-conductive bodies 406.

As indicated by dashed lines in FIG. 6, a portion of the non-conductive rollers 420, 422 is obscured from view, owing to that portion being received within a cavity defined in the exterior of the conductive body element 408. That is to say, the non-conductive rollers 420, 422 may be at least partially recessed within an outer profile of the conductive body element 408. Notably, the non-conductive rollers 420, 422 still at least partly project outwardly beyond the conductive body element 408 outer profile. The projecting nature of the non-conducting rollers 420, 422 facilitates the formation of a gap between an outer profile of the conductive body element 408 and the internal wall 136 of the volute 128.

The non-conductive rollers 420, 422 may be provided on pins, which act as axles, mounted to the conductive body elements 408. The non-conductive rollers 420, 422 may be plastic (e.g. Nylon) or ceramic. Any other suitable insulating material may otherwise be used in order to create a non-conductive barrier i.e. gap between the conductive body element 408 and the internal wall 136, so as to prevent short circuiting and/or arcing when electrochemical machining.

In the illustrated embodiment, a pair of diametrically opposed non-conductive rollers is provided at each end of the conductive body elements. For example, the non-conductive rollers 420, 421 form a first diametrically opposed pair at one end of the conductive body element 408, and the non-conductive rollers 422, 423 form a second diametrically opposed pair at a second end of the conductive body element 408. However, it will be appreciated that other arrangements are possible. For example, a circumferential distribution of any number of non-conductive rollers may be incorporated and attached to the conductive body element(s). Furthermore, non-conductive rollers may be provided at a range of different positions along a length of the conductive body elements. A range of different total numbers of non-conductive rollers may be provided, attached to each of the conductive body elements.

It will be appreciated that a gap, or clearance, between adjacent conductive body elements 408, 410, 412, 414, 416 facilitates the bending, or flexing, of the electrode 400 to conform to the volute 128. The conductive body elements may otherwise be referred to as conductive body segments.

An advantage of incorporating non-conductive rollers as the non-conductive body is that the rollers can be readily replaced, without requiring excessive disassembly of the electrode 400, should they become worn.

FIG. 7 is a schematic cross-section view of another embodiment of electrode 500 inserted in a volute 128. FIG. 7 shows the volute 128 in isolation of the rest of the turbine housing, in which the volute 128 is defined. The electrode 500 shares many features in common with the electrode 400 described in connection with FIG. 6 (and a number of features in common with the electrode described in connection with FIGS. 2-5), and only the differences will be described in detail.

FIG. 7 is a view taken normal to the flexible core 501, and (a single) conductive body element 502, which form part of the electrode 500. In practice, the electrode 500 may comprise a plurality of conductive body elements. At each outer side of the conductive body element 502, a non-conductive roller 504, 506, 508, 510 is provided. Each non-conductive roller 504, 506, 508, 510 is rotatably coupled to the respective side of the conductive body element 502 by a respective axle 512, 514, 516, 518. The axles 512, 514, 516, 528 may be pressed into the conductive body element 502, specifically an exterior of the conductive body element 502.

The sides of the conductive body element may be described as a radially inner side 520, a radially outer side 522, an upper side 524 and a lower side 526. When the electrode is inserted into the volute 128, as shown in FIG. 7, each of the sides 520, 522, 524, 526 is in facing relations, or adjacent, a corresponding radially inner side 528, radially outer side 530, upper side 532 and lower side 534 of the volute 128. The radially inner/outer naming convention identifies the side (of the conductive body element 502 or volute 128) with reference to the central axis 127 (around which the turbine housing extends). It will be appreciated that the aforementioned “sides” of the volute 128 may refer to portions of the internal wall which defines the volute 128. The sides may otherwise be described as sidewalls. The upper and lower sides of the conductive body element 502 and/or volute 128 may be referred to as axially outer and axially inner sides, or sidewalls, respectively.

The roller 504 on the radially outer side 522 of the conductive body element 502 is shown recessed into a pocket 536. The other rollers may also be recessed into corresponding pockets, or recesses.

As described in connection with FIG. 6, in use the electrode 500 is inserted into the volute 128 and the non-conductive rollers 504, 506, 508, 510 engage the internal wall 136 of the volute 128. The non-conductive rollers facilitate the insertion of the electrode 500 by rotatably engaging the internal wall 136, and urging the electrode 500 to flex to conform to the volute 128 geometry. The non-conductive rollers also define a gap between an outer profile of the conductive body element 502 and the internal wall 136, reducing the risk of arcing occurring, during an electrochemical machining process, between the components.

It will be appreciated that more, or fewer, non-conductive rollers may be used. It will also be appreciated that a variety of distributions of non-conductive rollers about an exterior of the conductive body elements are possible.

The rollers 508, 504 on the radially inner and outer sides 520, 522 of the conductive body element 502 may provide generally radial support (relative to the central axis 127). The rollers 506, 510 on the lower and upper sides 526, 524 of the conductive body element 502 may provide generally axial support (relative to the central axis 127).

The dimensions described in connection with the previous embodiments, referring to the clearances or gaps between the conductive and non-conductive bodies, are also equally applicable to this embodiment. That is to say, as a profile of the conductive body elements 408 (not including the conductive rollers) may be separated from the internal wall 336 by between 0.3 mm and around 2.5 mm.

Although the electrodes 400, 500 described and illustrated in connection with FIGS. 6 and 7 are flexible, it will be appreciated that the arrangement could also be applied to a fixed electrode. That is to say, the combination of non-conductive rollers rotatably attached to an exterior of a conductive body could equally be applied to an electrode having a core which is not flexible.

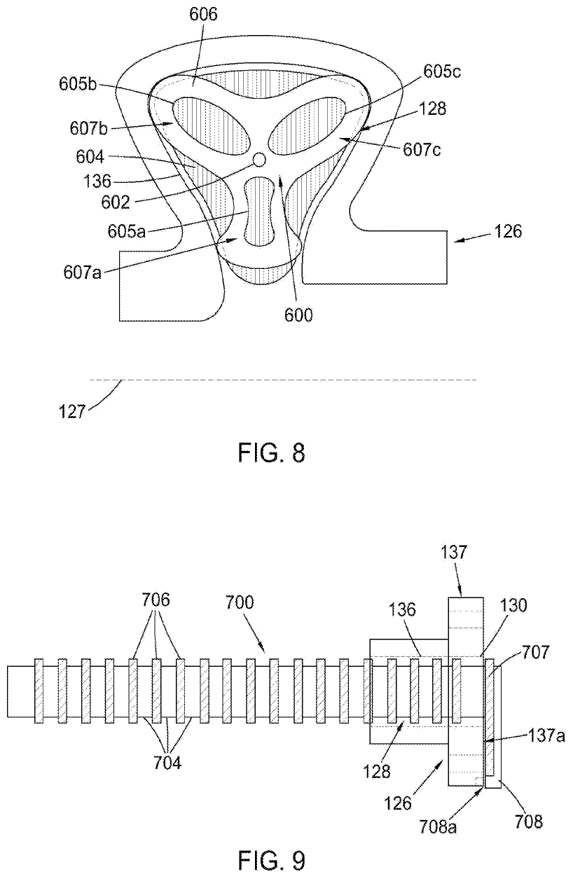

FIG. 8 is a schematic cross section view of part of another embodiment of electrode 600 inserted in a volute 128. Central axis 127 is also indicated, schematically, to aid interpretation of FIG. 8.

FIG. 8 shows the volute 128 largely in isolation of the rest of the turbine housing, in which the volute 128 is defined. The electrode 600 shares many features in common with the electrode described in connection with FIGS. 2-3c (and a number of features in common with the electrodes described in connection with FIGS. 4-7), and only the differences will be described in detail.

Turning to FIG. 8, the volute 128 is defined in a turbine housing 126. The volute 128 has a cross section which is generally triangular (e.g. it has three major sides).

The electrode 600 comprises a flexible core 602, conductive body 604 and non-conductive body 606. The conductive body 604 is in the form of a conductive plate. The conductive plate has a profile which generally conforms to the profile of the volute 128 (e.g. it is generally triangular, in this example). The conductive plate is solid (e.g. it does not incorporate any cavities), save for an aperture through which the flexible core 602 passes.

In contrast to previous embodiments, in FIG. 8 the non-conductive body 606 is in the form of a plate which comprises a plurality of cavities 605a-c. The non-conductive plate comprises three spoke-like projections 607a-c. The cavities 605a-c are formed in a respective one of the spoke-like projections 607a-c. The non-conductive plate may be described as star-shaped. Like previous embodiments, the non-conductive body 606 contacts the internal wall 136 of the volute 128. The non-conductive body 606 contacts the internal wall in positions generally corresponding to each of the projections 607a-c (specifically towards outer ends thereof).

Electrolyte can flow through the cavities 605a-c during electrochemical machining. This reduces the backpressure across the non-conductive body 606, which promotes the flow of electrolyte through the volute 128 (and generally around the electrode 600). This is achieved whilst still providing positional guidance to ‘suspend’ the conductive body 604 in proximity to the internal wall 136 (to facilitate electrochemical machining of the volute 128). The non-conductive body 606 therefore does not need to conform to the profile of the volute 128, or cavity more generally, in the same way as the conductive body 604.

The non-conductive body 606 may be described as a non-conductive plate. The non-conductive plate, or body, may be said to be non-solid, skeletal, hollow or a honeycomb structure. Although the illustrated non-conductive body 606 is in the form of a star-shaped plate, it will be appreciated that a range of other shapes are suitable (e.g. circular, square, rectangular, pentagonal etc.). It will also be appreciated that a range of cavity shapes, sizes, arrays/patterns and number can be incorporated to achieve the same effect (of permitting the flow of electrolyte thereacross). Incorporation of cavities also leads to a desirable reduction of the weight of the electrode 600.

Where the non-conductive body comprises a plurality of constituent bodies, such as a plurality of non-conductive plates, for example, each body, or plate, may comprise one or more cavities. Alternatively, only some of the constituent bodies, or plates, may comprise one or more cavities.

Like the previous embodiments, the non-conductive body 606 projects outwardly beyond the conductive body 604. In the illustrated embodiment the non-conductive body 606 projects outwardly beyond the conductive body 604 proximate outer ends of the projections 607a-c of the non-conductive body 606. Dashed lines which overlay the projections 607a-c indicate the profile of the conductive body 604 which is obscured from view by the non-conductive body 606.

The non-conductive body 606 preferably engages, or contacts, the internal wall in at least three different positions.

It will be appreciated that the hollow, or skeletal, nature of the non-conductive body 606, or any other features described above, may be incorporated in any of the electrode embodiments described in this document.

FIG. 9 is a schematic illustration of part of a further electrode 700 received in part of a volute 128 in a turbine housing 126. Only part of the turbine housing 126 is shown and, in particular, a flange 137, proximate an opening 130 of the volute 128, is visible. In the illustrated embodiment, the opening 130 is provided in the flange 137. The flange 137 may be a connection means by which the turbine housing 126 is connected to a conduit in use.

The electrode 700 is like the previous embodiments in that the electrode 700 comprises a conductive body 704 and a non-conductive body 706 (only parts of which are labelled in FIG. 9). The conductive and non-conductive bodies 704, 706 comprise a plurality of respective plates, and a flexible core (not visible) connects the conductive plates.

What distinguishes the electrode 700 from the previous embodiments it that, at an end of the electrode 700 that is proximate the opening 130, a non-conductive plate 707 projects outwardly beyond the opening 130. In use, at least part of the non-conductive plate 707 engages an outer face 137a of the flange 137. An adjacent conductive plate 708 also projects outwardly beyond the opening 130 and the non-conductive plate 707. As such, at least part (708a) of the conductive plate 708 is in facing relations with the outer face 137a of the flange 137, separated by a gap which is provided by the non-conductive plate 707.

The exposed part 708a of the conductive plate 708 can be used to machine a feature into the end face 137a of the flange 137. This can provide a visual indicator (e.g. a poka-yoke) that the volute 128 has been polished, and polished to its full depth. The machined feature can also be used as a counterfeit detection feature.

The non-conductive plate 707 and conductive plate 708 may be described as plates at an end of the electrode 700 and, more specifically, at a larger end (or free end) of the electrode 700. The non-conductive plate 707 and conductive plate 708 may be said to form an arm. The arm may be said to extend generally radially. The arm may extend generally radially by around 20 mm, for example. A machining feature may be provided at an end of the arm. An example of the machining feature is a 5 mm diameter hemisphere, although it will be appreciated that a wide range of other geometries, and features, could otherwise be machined into the outer face 137a.

It will be appreciated that the arm feature may be incorporated in any of the electrodes described in this document. It will also be appreciated that, although FIG. 9 does not show a tapering electrode 700, the electrode 700 may generally taper to facilitate the machining of a tapering volute.

Where dimensions are provided in this document, in relation to a gap or clearance between the conductive body and a profile of the volute, it will be appreciated that these dimensions refer to the profile of a cast volute i.e. before electrochemical machining occurs. For example, it is desirable that the conductive body outer profile lies within, or is recessed relative to, the profile of the cast volute by between around 0.3 mm and around 2.5 mm radially, and more preferably between around 1.1 mm and around 1.6 mm radially. Put another way, it is desirable that a radial gap of between around 0.3 mm and around 2.5 mm, and more preferably between around 1.1 mm and around 1.6 mm, exists between the conductive body outer profile and the internal wall of the cast volute.

An outermost profile of the non-conductive body may lie around 0.6 mm radially within the internal wall of the cast volute in situ. The outer profile of the conductive body may lie between around 0.5 mm and around 1 mm within the outermost profile of the non-conductive body. This may be based on standard sand casting tolerances, after the volute is cast.

Reducing a gap between the conductive body and the internal wall may provide a more significant, or stronger, magnitude of machining.

The conductive body and/or non-conductive body may be partly arcuate i.e. may be bent along its length. The electrode may comprise six, eight or ten such bodies. The electrode may comprise at least three non-conductive bodies, and at least three conductive bodies.

The volute may be referred to as a gas passage. The process described herein may be particularly advantageous when used on a cavity through which fluid flows in use, such as a pipe or other fluid passage.

Each non-conductive body may be slightly smaller than the cavity in its inserted location so that the electrode can be readily inserted. However, it will be appreciated that some points of contact may occur around the outer profile of the non-conductive body and the internal wall.

The electrode may be described as a modular electrode. The electrode may flex, bend, or deform during insertion and passage along the cavity.

The compressor housing may be referred to as a compressor cover.

The electrode may incorporate a distal end piece, which may be conductive, such that the electrode reaches the distal end of the volute.

The electrode may sit nearer to one side of the volute, where the cavity is a volute, due to manufacturing tolerances.

Where the component is a turbine housing, the manufacture process may be:
1. Sand moulding for initial casting geometry;
Shot blasting of cast geometry;
Gates/runners ground off;
Electrochemical machining process, as described in this document; Cosmetic blast.

The described and illustrated embodiments are to be considered as illustrative and not restrictive in character, it being understood that only preferred embodiments have been shown and described and that all changes and modifications that come within the scope of the disclosure as defined in the claims are desired to be protected. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

Optional and/or preferred features as set out herein may be used either individually or in combination with each other where appropriate and particularly in the combinations as set out in the accompanying claims. The optional and/or preferred features for each aspect of the disclosure set out herein are also applicable to any other aspects of the disclosure, where appropriate.

1. A method of electrochemically machining a cavity of a component using a flexible electrode, the flexible electrode comprising:
a flexible core;
a conductive body electrically coupled to the core; and
a non-conductive body;
the method comprising:
inserting the flexible electrode through an opening and along the cavity, at least part of an outer profile of the non-conductive body engaging an internal wall of the cavity; and
applying a negative charge to the flexible electrode, and providing a flow of electrolyte through the cavity to remove material from the internal wall.

2. The method according to claim 1, further comprising reciprocating the electrode within the cavity.

3. The method according to claim 1, wherein the at least a part of the outer profile of the non-conductive body projects beyond an outer profile of the conductive body.

4. The method according to claim 3, wherein the outer profile of the conductive body is spaced apart from the internal wall of the cavity by between around 0.3 mm and around 2.5 mm radially.

5. The method according to claim 1, wherein the non-conductive body comprises a plurality of non-conductive plates;
wherein the conductive body comprises a plurality of conductive plates; and
wherein the plurality of conductive plates interpose the plurality of non-conductive plates.

6. (canceled)

7. (canceled)

8. The method of claim 1, wherein the method further comprises providing the conductive body with a plurality of conductive body elements.

9. The method of claim 8, wherein the non-conductive body comprises a plurality of non-conductive rollers;
wherein the plurality of non-conductive rollers are rotatably coupled to the conductive body elements.

10. (canceled)

11. The method according to claim 1, wherein the cavity is a fluid conduit.

12. The method according to claim 11, wherein the flexible electrode extends through at least around 50% of an extent of the fluid conduit.

13. The method according to claim 11, wherein the cavity is a turbine housing volute or compressor housing volute.

14. The method according to claim 1, wherein the cavity is a first of a plurality of cavities, and the flexible electrode is a first of a plurality of flexible electrodes; and wherein a respective one of the plurality of flexible electrodes is received in each of the plurality of cavities.

15. A flexible electrode for electrochemically machining a cavity of a component, the electrode comprising:
a flexible core;
a conductive body electrically coupled to the core; and
a non-conductive body.

16. The electrode according to claim 15, wherein the electrode comprises a plurality of non-conductive bodies.

17. The electrode according to claim 16, wherein the non-conductive bodies comprise non-conductive plates.

18. The electrode according to claim 15, wherein the electrode comprises a plurality of conductive bodies.

19. The electrode according to claim 18, wherein the conductive bodies comprise conductive plates.

20. The electrode according to claim 17, wherein a plurality of conductive plates interpose a plurality of non-conductive plates.

21. The electrode according to claim 20, wherein an outer profile of the plurality of conductive plates, and the plurality of non-conductive plates, generally tapers from a first end of the electrode to a second end of the electrode.

22. The electrode according to claim 18, wherein the conductive bodies comprise conductive body elements.

23. The electrode according to claim 22, wherein the electrode comprises a plurality of non-conductive bodies, and wherein the plurality of non-conductive body comprises non-conductive rollers rotatably coupled to the conductive body elements.

24. (canceled)

25. The electrode according to claim 23, wherein an outer profile of the conductive body elements, and the non-conductive rollers, generally tapers from a first end of the electrode to a second end of the electrode.

26. An electrode arrangement comprising a plurality of electrodes according to claim 15.

27. A component comprising a cavity electrochemically machined using the method according to claim 1.

28. (canceled)

29. A component comprising a cavity electrochemically machined using the flexible electrode according to claim 15.
